(19) United States
(12) Patent Application Publication
(10) Pub. No.: US 2009/0115583 A1
(43) Pub. Date: May 7, 2009

(54) METHOD AND APPARATUS FOR DIGITAL SIGNAL INTEGRATED WITH POWER CABLE

(75) Inventor: GANG CHEN, Auckland (NZ)

Correspondence Address: YOUNG & THOMPSON, 209 Madison Street, Suite 500, ALEXANDRIA, VA, 22314, US

(73) Assignee: GANG CHEN, Auckland (NZ)

(21) Appl. No.: 12/258,541

(22) Filed: Oct. 27, 2008

(30) Foreign Application Priority Data
Nov. 5, 2007 (NZ) 563174

(51) Int. Cl. G05B 11/01

(52) U.S. Cl. 340/310.11

(57) ABSTRACT

A control system for vehicle accessories or similar items remote from the controls is connected via only the power connection to the accessories, the control signal being a pulse train impressed on the power connection. The modulation may be a frequency shift keyed waveform and each accessory may have a differing binary address train.

### TECHNICAL FIELD

The invention generally relates to multiplexing systems particularly for vehicles.

More particularly the invention relates to control of items on a vehicle over the power supply to the item.

### BACKGROUND ART

Vehicles have a number of items controlled from a central position, for instance headlamps, tail lamps, interior lights. Each of these may be separately wired to a control switch, and the control switch to a power source. In some circumstances the switch may merely control a relay which directs power to each of the items, but in each case wire heavy enough to carry the required power and any overload must be provided from the power source to the power using item. This results in many larger gauge copper wires running over extended distances in the vehicle.

It is known to reduce the amount of wire required by providing a single supply wire and providing switching signals over a separate smaller wire to a controller for each item located at the item. The signals involved are typically frequency or time multiplexed signals on the smaller wire, originating from a control source operated by the vehicle driver. The signals interact with a controller at the item to be controlled and provide either on/off or stepwise control. U.S. Pat. No. 4,370,561 describes such a system.

Similarly it is known to provide controllers and receivers on a power supply wire, with each controller and receiver operating on a different frequency, for instance as described in U.S. Pat. No. 4,463,341. This requires units of different tuning for each frequency.

Similarly it is known to impose a pulse train upon a power wire as a control signal as described in U.S. Pat. No. 5,517,172, however such signals are prone to interference from the vehicle electrical system.

The majority of such systems are complex and expensive to construct and require the routing of both a larger power wire and a smaller control wire to each item to be controlled. Systems imposing a pulse train upon a power wire are prone to interference and loading effects.

Therefore a need exists for a solution to the problem of providing control of remote items while using the minimum amount of connecting wire and a simple control system.

The present invention provides a solution to this and other problems which offers advantages over the prior art or which will at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the at, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

### SUMMARY OF THE INVENTION

In one exemplification the invention consists in a system for remotely controlling an electrically powered component or apparatus having a control signal receiver and a binary address by providing to a controller and a remotely powered component or apparatus a common power supply connection, impressing upon the connection a modulated signal, the modulating signal supplied comprising a pulse train, the pulse train including a binary address of a remote receiver, at the receiver detecting modulation upon the power connection, extracting from the modulation the modulating pulse train, extracting from the pulse train the binary address, comparing the extracted address with the address of the remote component or apparatus, and where the addresses match controlling the electrically powered component or apparatus.

wherein the modulated signal is frequency shift modulated.
wherein the pulse train has pulse groups each pulse group starting with a single pulse and being followed by a series of address pulses.
wherein an audio signal is also impressed upon the power connections.
wherein the control supplies power to or removes power from the component or apparatus.
wherein the power connection is supplied from a power source to the controller and receiver and there is a high impedance at the modulated signal frequency between the power source system.

A method of providing a control signal to a remote component or apparatus by providing a common power connection to a signal transmitter and at least one associated signal receiver from a power source, providing to each receiver a binary address, providing an impedance at a radio frequency between the power source and the power connection, impressing on the power connection a signal at the radio frequency, modulating the modulated signal with a pulse train, the pulse train including a binary address of a receiver.

A transmitter to supply a control signal to a remote receiver and having; a pulse generator capable of generating a required pulse train, the pulse train representing a binary address and a train commencement pulse, a radio frequency signal generator, a modulator modulating the pulse train onto the generated radio frequency signal, a radio frequency signal coupler coupling the generated radio frequency signal onto a power supply line common to the transmitter and any remote receiver.

A receiver powered by a power supply line common to a controlling transmitter and controlling an electrical component or apparatus and having: a settable binary address, a signal detector extracting a radio frequency signal from the power supply line, a demodulator recovering the modulation signal from the signal detector, a pulse train extractor extracting from the modulation signal a pulse train commencement pulse and a trailing series of pulses representing a binary address, a comparator comparing the received binary address with the settable binary address and controlling an electrical component or apparatus in accordance when addresses match.

These and other features of as well as advantages which characterise the present invention will be apparent upon reading of the following detailed description and review of the associated drawings.

### BRIEF DESCRIPTION OF THE DRAWINGS

FIG. 1 is a circuit diagram of a transmitter circuit for use with the multiplex system.

FIG. 2 is a circuit diagram of a receiver circuit for use with the multiplex system.

FIG. 3 is a block diagram of the system

FIG. 4 illustrates some possible pulse address trains

### DESCRIPTION OF THE INVENTION

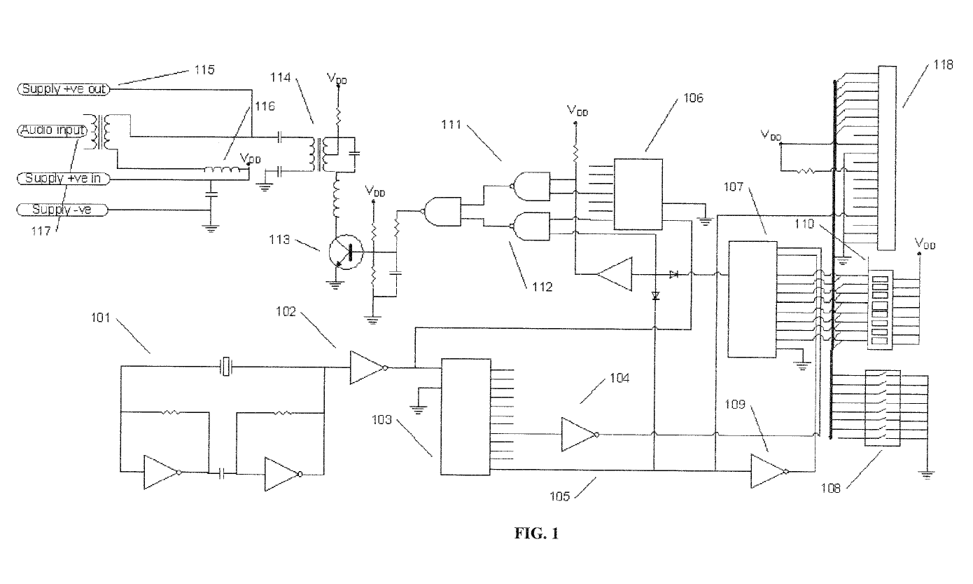

Referring now to FIG. 1 this shows the circuit of one exemplification of a transmitter for a system in which a crystal oscillator (101) at a frequency of 3.6 MHz is buffered by inverter (102) supplying a clock to 14 bit binary counter (103) and to 7 stage ripple counter (106). The latter provides two outputs; a repetitive pulse every eight clock pulses (225 KHz) to gate circuit (111) and a repetitive pulse every second clock pulse (1.8 Mz) to gate circuit (112). The clock to binary counter (103) produces via inverter (104) a pulse every 214 clocks to shift register (107). This preloads the shift register from switches (108), loaded by resistors (110), and as the counter (103) counts each 2¹⁰ pulse it clocks the shift register producing an output from each 2⁸ clock pulses, or at 225 KHz in the instance shown, which is passed to gate (111) as a serial conversion of the parallel switch bits. Bit 8 is always high to act as a constant lead bit for the changing address bits following. As a result of the preload from switches (108) the output produced is a seven bit binary code which acts as the address of a receiver on the multiplex system and which is preceded by a single mark bit, the bits being represented by a 225 KHz frequency for a high bit and at 1.8 MHz for a low bit.

The output of gate (111) drives amplifier (113) and produces via tuned transformer (114) output (117) which is isolated from the 12 volt supply (115) by inductor (116). The output at (115) is thus a 12 volt supply line with an alternating frequency impressed upon it of either 1.8 MHz or 225 KHz. This provides a pulse code modulated frequency shift keyed digital signal of substantially constant amplitude. An audio signal may be impressed via a transformer directly onto the frequency modulated 12 volt line at (117), however this is entirely optional.

A connector (118) is provided to allow connection of a remote controller facility for setting the address to be impressed on the power supply line. This allows the dynamic addressing of up to 128 controllers from the transmitter in a 7-bit system.

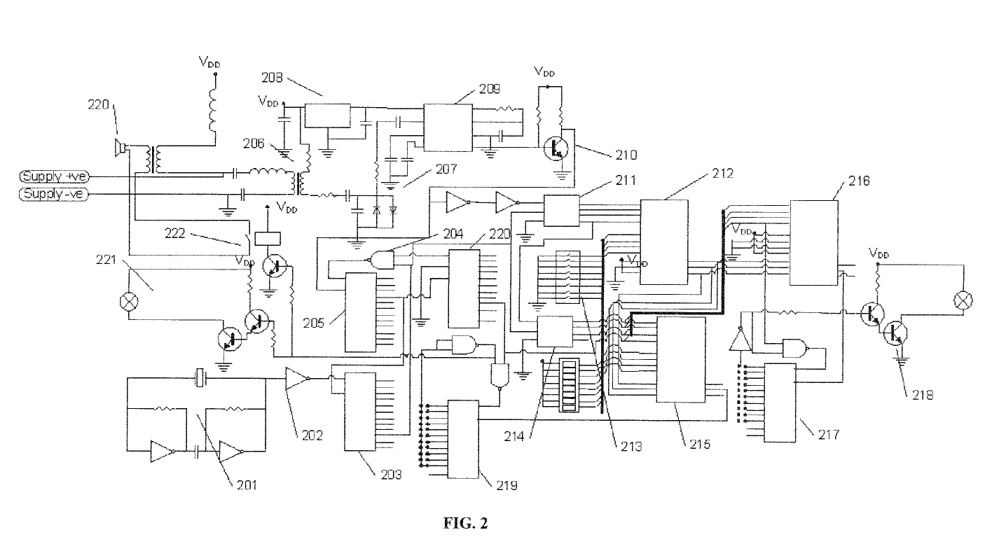

The companion receiver to the transmitter of FIG. 1 is shown in FIG. 2 and has a crystal oscillator (201) on substantially the same frequency as the transmitter. Output from this is buffered at (202) and supplied to a 12 bit binary counter (203). Every 210 clock counts the output of this counter goes high and serves to clock both parts (214) and (211) of a dual 4-stage shift register, a decoder divider (220) and, via gate (204) a second 12 bit binary counter (205). Divider (220) supplies a pulse every 2⁸ clocks to 12 bit binary counter (219).

The 12 volt line with the binary address frequency shift modulated on to it is retrieved at (206) via a transformer and passed via limiting circuitry (207) to a phase locked loop at (209) powered by voltage from regulator (208) supplied from the 12 volt line. The phase locked loop acts to retrieve the transmitted pulses as a wave train and supplies them to the data inputs of shift register (211). Clocked by the output of counter (203) this shift register passes the least significant half of the received pulse train to magnitude comparator (212) while the most significant half is passed to shift register (214) where it is supplied to magnitude comparator (215). Comparison at magnitude comparator (212) against the settings of the least significant of switches (213) provides a “greater than”, a “less than” and an “equal to” signal to both magnitude comparator (215) and to magnitude comparator (216). When the received pulse train as detected at the magnitude comparators matches the setting of switch (213) the comparator output resets 12 bit binary counter (219) and toggles on or off the output circuit at (221).

Comparator (216) also co-operates with comparator (212), in having a differing more significant address sequence than comparator (216) to operate switched output (218) via 12 bit binary counter (217). Multiple comparators (216), (217) and output controls (218) may be provided to act as controllers responding to differing addresses.

While the figures show the use of standard logic components for the digital function die functions of the transmitter and receiver may be provided by any other suitable circuitry, for instance a programmed microcontroller may carry out the required functions at either transmitter or receiver. Similarly while the circuit described uses an 8 bit binary control signal any number of bits may be used provided that matching addresses are available at transmitter and receiver.

While the isolating impedance between transmitter and the 12 volt power source is shown as an inductor any other component or combination of components may be used provided the required isolation is obtained.

Because the system provides a constant RF signal of switched frequency to the power line the receivers are always receiving an RF signal of some frequency and of trackable amplitude, This provides a comparatively stable environment at the receivers in that while variation of the loading on the power supply affects the amplitude of the received signal it leaves the frequency shift keyed modulation intact and unaffected by the typical vehicle environmental electrical noise of alternator ripple, ignition noise, alternator slip ring hash and injector solenoid transients.

FIG. 3 shows a block diagram of such a system where power supply connections (301) provide power both to supply the elements of the transmitter and receiver and the power to whatever components or apparatus are controlled by the receivers. At (302) an impedance which reduces leakage of the radio frequency signal back into the power supply is provided, this impedance may be specifically tuned to reject the control frequencies if high rejection is desired. A transmitter of pulse train creator (303) and radio frequency modulator and generator (310) couple a modulated RF signal into the power supply line which is further connected to receivers (304), (305), (306).

Control elements (307), (308), (309), shown as switches, are each associated with a specific binary address, such that changing the state of the switch causes the binary address to be provided to the output of (303) to be modulated as a frequency shift keyed waveform transmitted onto the power connection.

At receiver (304), (305), (306) the RF waveform is received, extracted, and the binary addresses decoded. Where an address matches the receiver binary address a relay such as (311), (315), (319) will be toggled and via contacts (313), (317), (321) a load (314), (318), (322) will be either connected or disconnected. Impedances (312), (316), (320), which are typically inductances, prevent the loads from bypassing the control voltages.

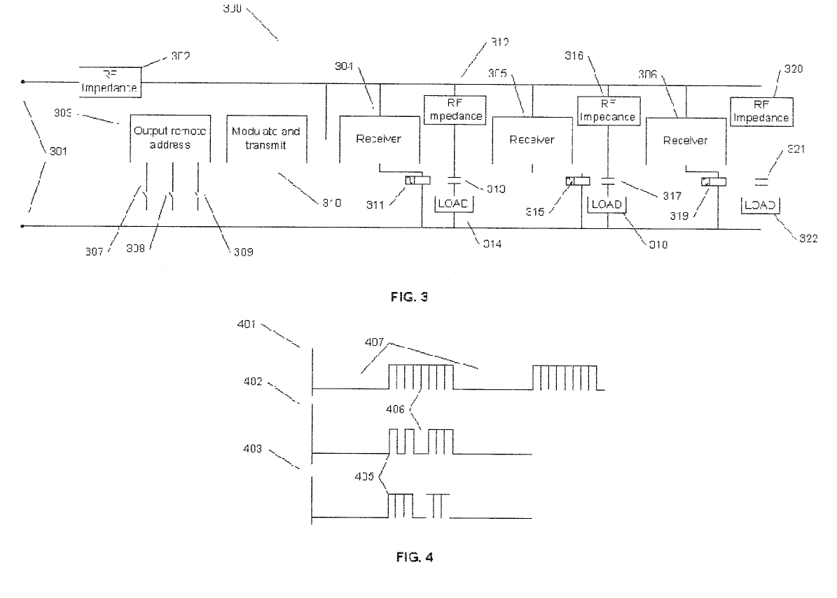

The amplitude of the waveform at the significant one of the frequency shifted control frequencies is shown in FIG. 4. It should be remembered that where the significant frequency is not shown there will be a waveform at the non-significant frequency imposed on the supply voltage. One occurrence of the significant pulsed address waveform for three differing addresses is shown in FIG. 4 where a start bit (405) appears at the start of each address. Address (401) shows an address with all seven bits of address (406) high and a binary value equivalent to address (127), address (402) shows an address equivalent to 39 and (403) an address equivalent to 103. Using seven address bits up to 128 receivers may be controlled or alternatively a single receiver may control some apparatus which requires 128 steps of control. Gaps (407) in which no pulse train appears is also 8 bits long and contains a continuous transmission at the non-significant control frequency. This ensures that the control pulses are regularly spaced and that the control voltage amplitude is always constant.

The address may be any number of binary bits long, and the interval between trains of address pulses is preferably equal to the length of a maximal address pulse. The address and pulse trains may be any length and at any usable frequency but preferably are such as to allow an apparently undelayed response to the operation of the control element regardless of the number of addresses catered for. The interval between pulses and the repetition rate of the pulses is also mediated for the desired throughput. Preferably each pulse slot contains 16 cycles of the higher shift frequency, each pulse train contains 16 pulse slots, each pulse train set contains 128 pulse trains, This allows control of 128 differing units from a single supply line.

The radio frequency chosen for the highest shift frequency is preferably in one of the unlicensed radio bands, for instance 225 KHz, although pulse width or pulse code modulation may be used instead of frequency shift modulation.

While the system described is a DC powered system applicable to a vehicle the system is applicable to AC powered control of remote, accessories or apparatus.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the circuits may vary dependent on the particular application for which it is used without variation in the spirit and scope of the present invention.

In addition, although the preferred embodiments described herein are directed to a multiplex system for use in a vehicle, it will be appreciated by those skilled in the art that the teachings of the present invention can be applied to other systems such as aircraft or items supplied from alternating current, without departing from the scope and spirit of the present invention.

### INDUSTRIAL APPLICABILITY

The control apparatus of the invention is used in the remote control and management of electrically powered items which are employed in the vehicle or electrical industry. The present invention is therefore industrially applicable.

1. A system for remotely controlling an electrically powered component or apparatus having a control signal receiver (304) responding to at least one binary address by providing to a controller and a remotely powered component or apparatus (314) a common power supply connection (312), impressing upon the connection at the controller a modulated radio frequency signal (310), the modulating signal comprising a pulse train (303, 308, 402), the pulse train including a binary address (405), at a receiver detecting modulation upon the power connection (207), extracting from the modulation the modulating pulse train (209), extracting from the pulse train the binary address (204, 211, 214), comparing the extracted address with the address of the remote component or apparatus (212, 213, 215), and where the addresses match controlling the electrically powered component or apparatus (221) characterised in that the controller continuously provides a modulated signal (111, 112, 113).

2. A system as claimed in claim 1 characterised in that the modulated signal is frequency shift modulated.

3. A system as claimed in claim 1 characterised in that the pulse train has pulse groups each pulse group starting with a single pulse and being followed by a series of binary address pulses.

4. A system as claimed in claim 1 characterised in that an audio signal is also impressed upon the power connections.

5. A system as claimed in claim 1 characterised in that the control supplies power to or removes power from the component or apparatus.

6. A system as claimed in claim 1 characterised in that the power connection is supplied from a power source to the controller and receiver and there is a high impedance at the modulated signal frequency between the power source and the control system.

7. A transmitter (303, 310) for use in the system of claim 1 to supply a control signal to a remote receiver (304) and having a pulse generator (107) capable of generating a required pulse train, the pulse train representing a binary address and a train commencement pulse (406), a radio frequency signal generator (101, 102, 106), a modulator frequency shift modulating the pulse train onto the generated radio frequency signal (111, 112), a radio frequency signal coupler (114) coupling the generated radio frequency signal onto the power supply line common to the transmitter and any remote receiver.

8. A receiver for use in the system of claim 1 powered by a power supply line common to a controlling transmitter and controlling an electrical component or apparatus and having at least one settable binary address (213), a signal detector (207) extracting a radio frequency signal from the power supply line, a demodulator (209) recovering the modulation signal from the signal detector, a pulse train extractor extracting from the modulation signal a pulse train commencement pulse and a trailing series of pulses representing a binary address (209, 210), a comparator (212, 215) comparing the received binary address with the at least one settable binary address characterised in controlling an electrical component or apparatus in accordance when addresses match (221).

9. A method of providing a control signal to a remote component or apparatus by providing a common power connection (312) from a power source to a signal transmitter (310) and to at least one signal receiver (304) having at least one binary address (406) associated with a component or apparatus, providing an impedance (302) at a radio frequency between the power source and the power connection, impressing on the power connection from the transmitter a signal at the radio frequency, modulating the signal with a pulse train (406), the pulse train including a binary address (405), detecting at least one receiver the modulated signal (207) and extracting the binary address from the pulse train (209), comparing the binary address with the receiver address or addresses (212, 215), and controlling a component or apparatus (221) where the binary addresses match characterised in that the modulated control signal is continuously present.

10. A method as claimed in claim 9 characterised in that an audio signal is also impressed upon the common power connection by the signal transmitter.

11. A method as claimed in claim 9 characterised in that the pulse train includes a leading pulse which is always present.
